(19) United States
(12) Patent Application Publication
(10) Pub. No.: US 2009/0030782 A1
(43) Pub. Date: Jan. 29, 2009

(54) Methods For Obtaining Leads

(76) Inventors: Liza Haworth, Valencia, CA (US); Gustavo Escamilla, La Canada Flintridge, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/782,542

(22) Filed: Jul. 24, 2007

(51) Int. Cl. G06Q 30/00

(52) U.S. Cl. 705/14

(57) ABSTRACT

There are disclosed methods for obtaining leads for a service provider. The service provider may supply marketing support to a seller having a real property available for sale. The marketing support may include marketing materials containing unique contact information to direct inquiries to the service provider. The service provider may inquiries from one or more potential buyers in response to the unique contact information. The service provider may respond to the inquiries from the potential buyers on behalf of the seller and may collecting buyer contact information of the potential buyers for use as leads.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to methods for obtaining business leads, such as leads for lenders and other businesses.

2. Description of the Related Art

Real estate is commonly sold with the assistance of a real estate broker or agent who represents the seller and provides marketing services for the seller in exchange for a commission, usually equal to a fraction of the selling price. Other sellers may sell real estate without the use of a real estate broker. A property that is being marketed without the use of a real estate broker is commonly termed a “FSBO” (For Sale By Owner).

There are a number of providers that supply services to assist the seller of a FSBO property. The services provided commonly include posting the FSBO property on a Web site such as www.financethishome.com, www.forsalebyowner.com, www.fsbo.com, www.byowner.com, www.owners.com, www.buyowner.com, and www.isoldmyhouse.com. Services provided to FSBO sellers may also include preparation of custom signs and preparation of customer marketing literature such as flyers, mailers, postcards and e-mail marketing. These services may be provided to the FSBO seller at a fixed price that may be substantially less than the commission paid to a real estate broker.

### DESCRIPTION OF THE DRAWINGS

FIG. 1 is a flow chart of a process for obtaining leads.

FIG. 2 is a flow chart of a process for obtaining leads.

FIG. 3 is a detailed flow chart of a portion of the process of FIG. 2

FIG. 4 is a flow chart of a process for obtaining leads.

FIG. 5 is a block diagram of a system for obtaining leads.

### DETAILED DESCRIPTION

Throughout this description, the embodiments and examples shown should be considered as exemplars, rather than limitations on the apparatus and methods disclosed or claimed.

Description of Processes

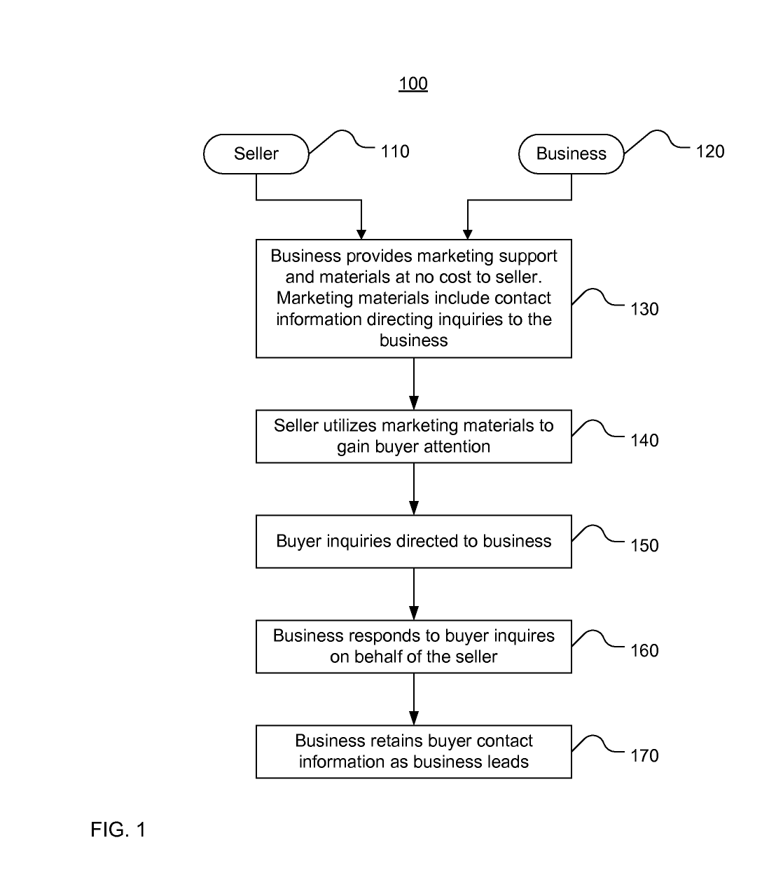

Referring now to FIG. 1, a process 100 for obtaining business leads may begin with a seller 110 and a business 120. The seller 110 may have an item of property for sale, and the business 120 may provide goods or services related to the property being sold by the seller 110. At 130, the business may provide marketing support to help the seller's efforts to sell the property. The marketing support may be provided without cost to the seller. The support may include marketing materials that include contact information that will direct inquiries to the business rather than to the seller.

At 140, the seller utilizes the marketing materials, which may include signs, flyers, mailers, advertising templates, other marketing literature, and a Web site to gain the attention of potential buyers and other interested parties. At 150, at least some of the potential buyers and interested parties may make inquiries using the contact information on the marketing materials. These inquires will be directed to the business. Having inquiries directed to the business relieves the seller from having to respond to recurring inquiries, and places the business in contact with inquiring parties interested in the property and thus possibly interested in the related goods and services provided by the business and its other professional partners.

At 160, the business may respond to the inquires on behalf of the seller. At 170, the business may retain the contact information obtained from the inquires for use as future business leads.

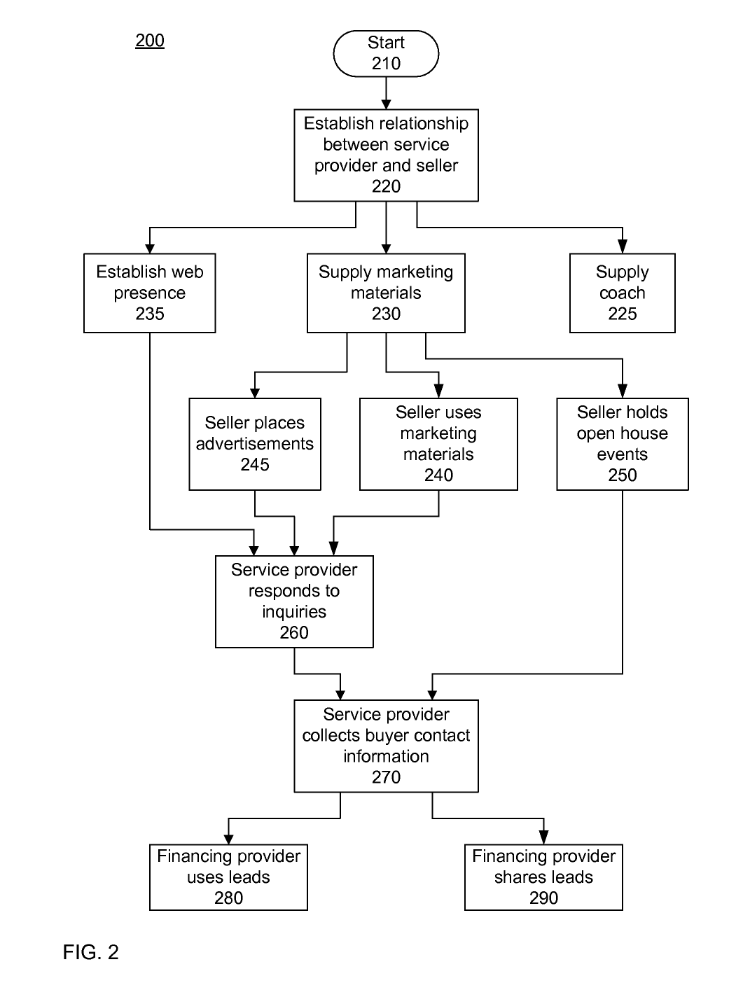

A more detailed example of a process 200 for obtaining leads is shown in FIG. 2. For this example, the business is assumed to be a service provider that provides services related to the sale or purchase of real estate, and the seller is assumed to have a first real estate property available for sale. The service provider may be a lender such as a bank, a savings and loan, a mortgage banker, or other financial institution that will lend, or assist in lending, the portion of a purchase price to buyer. The service provider may provide repairs, remodeling, property insurance, title insurance, appraisal, moving, inspection, pest control, escrow services, or other services related to the sale or purchase of real estate. The service provider may act through an agent, representative, or subcontractor. The service provider may be a mortgage broker who arranges financing for a buyer.

The process 200 starts at 210 and continues at 220 where a relationship is established between the service provider and the seller. The relationship between the service provider and the seller may be a contract or other agreement that requires the service provider to supply defined marketing support to the seller in return for the seller performing defined actions. For example, the seller may agree to perform actions such as holding a predetermined number of “open house” events, requiring potential buyers who attend the open house events to provide buyer contact information, allowing a sign to be installed in front of the first real estate property, distributing or making available marketing material supplied by the service provided, and/or placing a predetermined number of newspaper advertisements. The service provider may provide the marketing support without cost to the seller or at a reduced cost to the seller in return for the seller, in effect, helping the service provider to generate leads.

After the relationship between the service provider and the seller is established at 220, the service provider may supply marketing materials to the seller at 230. The marketing materials may include one or more signs containing property contact information to direct inquiries from potential buyers to the service provider. The marketing materials may also include printed materials, such as flyers, postcards, and other advertising literature, all of which may contain the property contact information. The one or more signs and the printed materials may be unique to the first real estate property.

In this description, the term “property contact information” means contact information that directs inquiries from potential buyers to resources established by the service provider to distribute information relating to a specific property. The property contact information may include at least one of a phone number and a URL for accessing an online presence of the first real property. The resources established by the service provider may include one or more of the online presence, a call center, and a unique phone number accessing a prerecorded message relating to the first real property.

The marketing support supplied by the service provider may also include establishing the online presence, at 235, of the first real estate property in the form of a dedicated Web site, a Web page, or other online presence. The online presence established by the service provider may include a Web site where information relating to the first real property may be accessed by means of a unique identifier (provided as part of the property contact information) or by searching (for the property address, for example).

The one or more signs, the printed materials, and the online presence supplied by the service provider may contain information relating to the first real property and information describing the services provided by the service provider, in addition to the property contact information. For example, if the service provider is a financing provider such as a mortgage lender or a mortgage broker, the signs, the printed materials and the online presence may include information describing the terms of loans that may be offered for financing the purchase of the first real property.

The marketing support supplied by the service provider to the seller may also include the services of a consultant or coach at 225. The coach may provide guidance to the seller about marketing the first real estate property. For example, the coach may provide advice to the seller on preparing the first real estate property for sale. The coach may also provide advice to the seller on technical aspects of a real estate sales transaction, such as the required documents and disclosure forms. The coach may also refer the seller to a licensed real estate agent, Web site, or other resources to assist with the real estate transaction.

At 240, the seller may utilize the marketing materials to generate inquiries from parties interested in the first property. For example, the seller may erect a sign in front of the first real estate property and may make flyers available to people who pass the first real estate property. The seller may also distribute flyers by hand and may distribute flyers, postcards, or other descriptive literature by mail and/or e-mail. The seller's utilization of the marketing materials may generate inquiries from interested parties including persons actively seeking to purchase a real estate property, neighbors, owners of similar properties, real estate agents, and other persons. Within this description, the interested parties will be collectively referred to as “potential buyers”. The contact information for the potential buyers will be referred to as “buyer contact information” to avoid confusion with the previously defined “property contact information”.

At 245, the seller may also place advertisements containing the property contact information in newspapers, magazines, or other media.

At 260, inquires made in response to the marketing materials and advertisements may be received by the service provider, or by the resources established by the service provider, who may respond to the inquires on behalf of the seller. The responses to the inquiries may include both information relating to the first real property and information relating to the services available from the service provider. The information relating to the first real property may include the seller's name and/or contact information. The information relating to the first real property may be limited to the seller's name and/or contact information. The information relating to the first real property may include information describing the first real property. The responses may also invite potential buyers to provide buyer contact information. For example, the potential buyers may be asked to provide their contact information in order to receive additional information on the first real property or the services offered by the service provider.

The seller may hold “open house” events at 250 where potential buyers and other interested parties may view the first real property. The seller may make marketing materials available to the potential buyers and other interested parties who visit the open house event, and may offer a guest book or sign-up sheet where potential buyers may leave buyer contact information.

The buyer contact information from the open house events, as well as buyer contact information from inquiries in response to advertisements and marketing materials, may be collected by the service provider at 270. The service provider may use the buyer contact information as business leads at 280, and may share the buyer contact information with other providers of goods and services relating to real estate transactions at 290. For example, if the service provider is a financing provider, the other providers may include, but not be limited to, real estate agents and brokers, title insurance and escrow companies, and other companies that provide appraisal, repairs, remodeling, insurance, moving, inspection, home warrantee, and other services relating to real estate transactions.

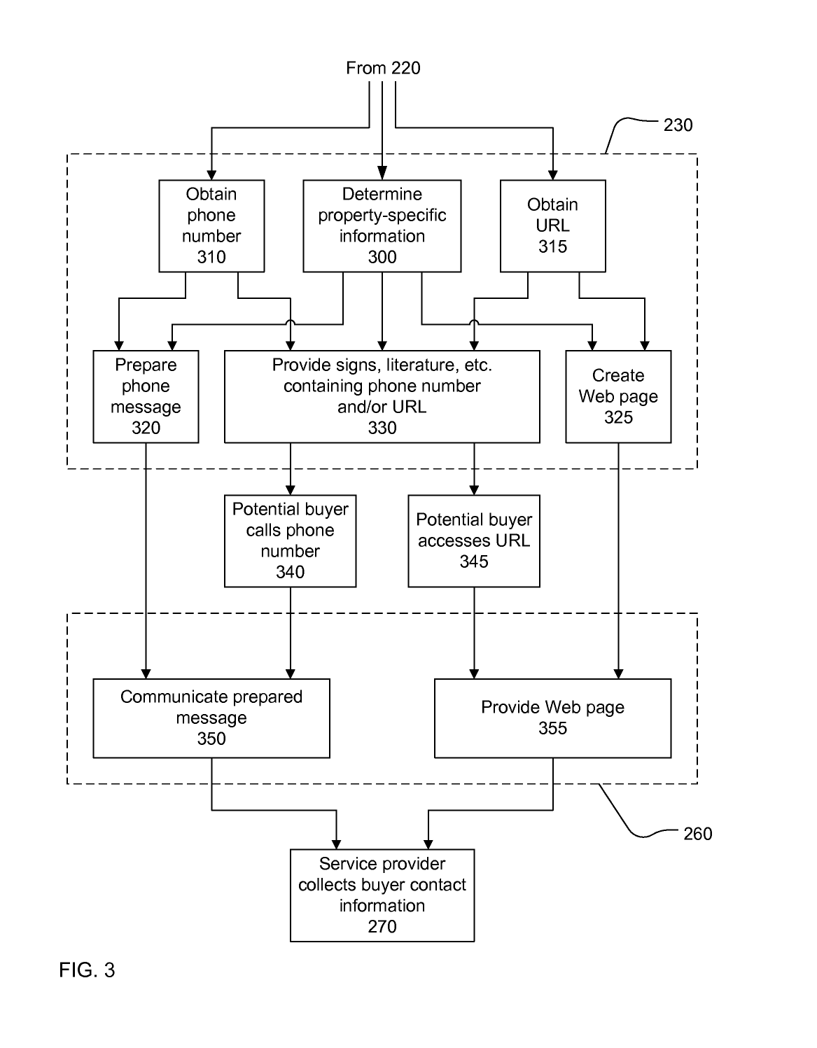

Turning now to FIG. 3, details of a portion of a process for obtaining business leads, which may be the process 200, are shown. In FIG. 3, reference designators between 220 and 270 refer to elements having the same general function as the elements in FIG. 2 having the same reference designators.

After a relationship is established between a service provider and a seller at 220, the service provider may prepare and supply marketing materials at 230. The marketing materials may contain property contact information which may include a phone number, a URL, and other contact information. A phone number for inclusion in the marketing material may be obtained at 310. The phone number may be a toll-free number or a local phone number. The phone number be dedicated to the first real property, or may shared by multiple properties or used for other purposes. A dedicated phone number may be obtained by requesting new service from a telecommunications company, or may be selected from an inventory of existing phone numbers available to the service provider.

If a phone number will be included in the property contact information on the marketing materials, a phone message specific to the first real property may be prepared at 320. This phone message may be a prerecorded message, or may be a script for a human operator who answers calls placed to the phone number. The prepared phone message may include information relating to the first real property and may include information describing the services available from the service provider. The phone message may invite a caller to provide buyer contact information.

A URL may be obtained at 315. The URL may be dedicated to the first real property. The URL may direct potential buyers to a Web site presenting a plurality of for-sale-by-owner properties. In this case, an additional identifier, unique to the first real property, may be included in the property contact information. Alternately, the potential buyer may be required to use a search function to locate the first real property. Ultimately, the potential buyer may view a web page dedicated to the first real property.

If a URL is included in the property contact information, a Web page dedicated to the first real property may be created at 325. The Web page may be a stand-alone page having a URL unique to the first real property, or may be a page added to an existing Web site. The Web page may include information and photographs relating to the first real property, and may contain information describing the service available from the service provider and/or its partners. The Web page may invite a viewer to provide buyer contact information. The Web page may allow potential buyers to print marketing information regarding the first real property or other property of interest directly from the Web site. The Web page may also allow potential buyers to e-mail the service provider and/or the seller directly from the Web page.

At 300, property-specific information relating to the services offered by the service provider may be determined. For example, if the service provider is a financing provider, the property-specific information may include that terms of one or more financing options that may be available to potential buyers of the first real property.

After the phone number and/or URL are obtained at 310 and 315, and the property-specific information is determined at 300, marketing materials containing the phone number, URL, and other property contact information, as well as property-specific information, may be prepared and provided to the seller at 330. The seller may then employ the marketing materials to attract the interest of potential buyers. The potential buyers may then call the phone number at 340 and receive the prepared phone message at 350. The potential buyers may also access the URL at 345 and view the Web page at 355.

Both the prepared phone message and the Web page may include an invitation for the potential buyers to provide buyer contact information. The buyer contact information may be collected by the service provider at 270.

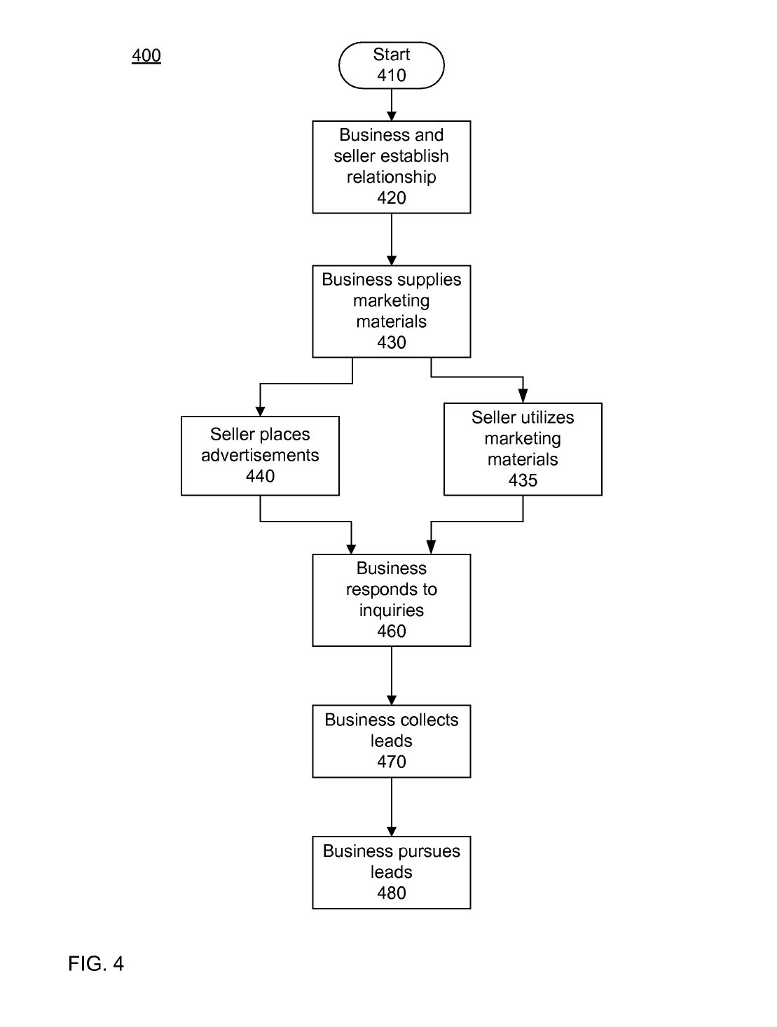

Referring now to FIG. 4, an exemplary process for obtaining leads 400 starts at 410 and continues at 420 where a relationship is established between a business and a seller who may have a first property available for sale. In the example of FIG. 4, the first property is not limited to a real estate property, but may be any high value property such as an automobile, boat, recreational vehicle, airplane, artwork, or industrial equipment. The business may be a lender such as a bank, a savings and loan, a credit union, or other financial institution that will lend a portion of a purchase price to buyer. The business may provide goods or services relating to the first property, including but not limited to repairs, refurbishment, insurance, accessories, and other products or services.

The relationship between the business and the seller may be a contract or other agreement that requires the business to supply defined marketing support to the seller in return for the seller performing defined actions. For example, the business may provide marketing support to the seller in return for the seller agreeing to place a predetermined number of newspaper advertisements. The relationship between the business and the seller may be non-contractual. The business may provide the marketing support without cost to the seller in return for the seller providing contact information for potential buyers to the business.

After a relationship between the business and a seller is established at 420, the business may supply marketing materials to the seller at 430. The marketing materials may include one or more signs containing property contact information to direct inquiries from potential buyers to the business. The property contact information may be as previously described in conjunction with FIG. 2. The marketing materials may also include printed materials, such as flyers, postcards, and other advertising literature, as well as a Web presence, containing the property contact information. The one or more signs and the printed materials may be unique to the first property.

At 435, the seller may utilize the marketing materials to generate inquiries from parties interested in the first property. For example, the seller may place signs in the windows of a recreational vehicle and leave the vehicle parked at some high-traffic public location. The seller may also distribute flyers by hand and may distribute flyers, postcards, or other descriptive literature by mail. The seller's utilization of the marketing materials may generate inquiries from interested parties including potential buyers.

At 440, the seller may also place advertisements containing the property contact information in newspapers, magazines, or other media.

At 460, inquires made in response to the marketing materials and advertisements may be received by the business (since the marketing materials may contain property contact information that directs inquires to resources established by the business) who may respond to the inquires on behalf of the seller. The responses to the inquiries may include both information relating to the first property and information relating to the services available from the mortgage provider. The responses may also invite potential buyers to provide buyer contact information in order to receive additional information on the first real property or the services offered by the business and their partners.

The buyer contact information from inquiries in response to advertisements and marketing materials may be collected by the business at 470. The business may use the buyer contact information as business leads at 480. The business may also share the buyer contact information with other providers of goods and services relating to the first property.

Description of Apparatus

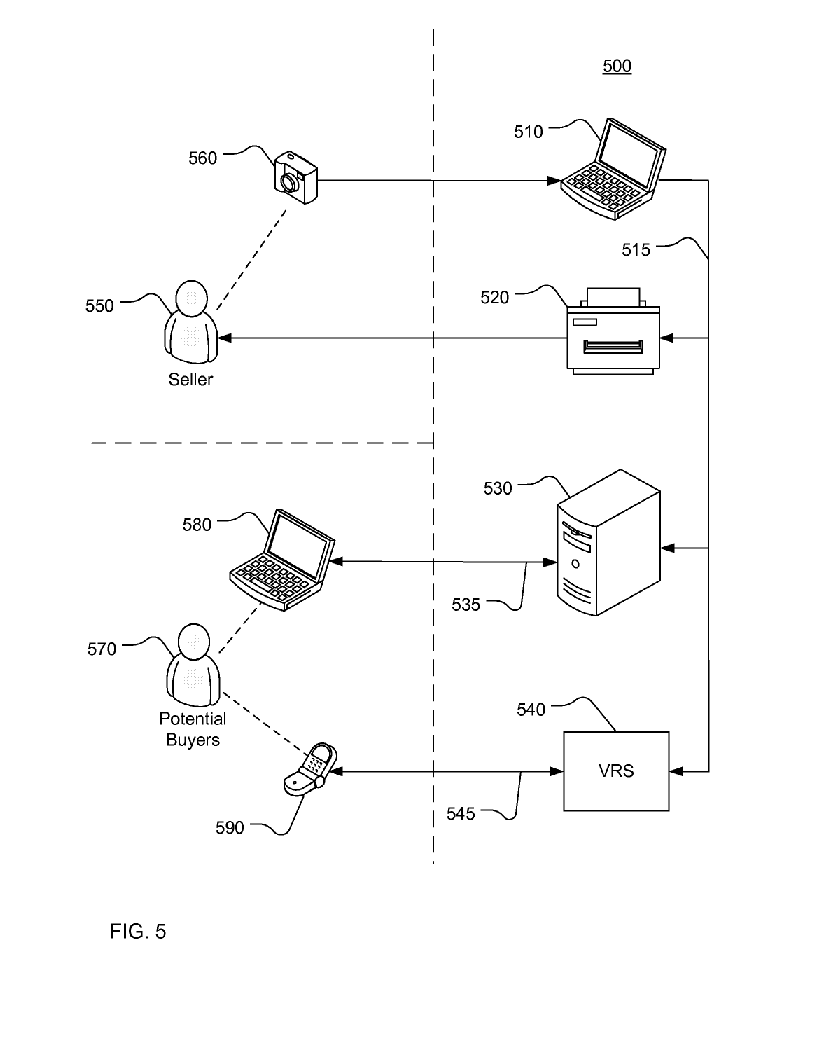

FIG. 5 is a block diagram of an exemplary system 500 for obtaining leads. The system 500 may be compatible with the processes 100, 200, 400, and other processes for obtaining leads. The system 500 may include at least one computing device 510, at least one printer 520, at least one server 530, and a voice response system (VRS) 540.

Although the computing device 510 is shown implemented in a laptop computer, the processes and apparatus may be implemented with any computing device. A computing device as used herein refers to any device with a processor, memory and a storage device that may execute instructions including, but not limited to, personal computers, server computers, computing tablets, personal digital assistants (PDAs), portable computers, and laptop computers. These computing devices may run an operating system, including, for example, variations of the Linux, UNIX, MS-DOS, Microsoft Windows, Palm OS, Solaris, Symbian, and Apple Mac OS X operating systems.

The hardware and firmware components of the computing device 510 may include various specialized units, circuits, software and interfaces for providing the functionality and features described here. The processes, functionality and features may be embodied in whole or in part in software which operates on the computing device and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by the computing device 510 and others by other devices.

The computing device 510 may include, or be coupled to, a storage device. As used herein, a storage device is a device that allows for reading and/or writing to a storage medium. Storage devices include hard disk drives, DVD drives, flash memory devices, and others. Storage media that may be used within a storage device include, for example, magnetic media such as hard disks, floppy disks and tape; optical media such as compact disks (CD-ROM and CD-RW) and digital versatile disks (DVD and DVD±RW); flash memory cards; and other storage media. The storage media may hold computer-readable instructions that, when read by computing device 510, cause computing device 510 to perform all or a portion of a process for obtaining leads, as previously described.

The computing device 510 may receive information relating to a property for sale, such as digital photos of the property from camera 560. The photos of the property for sale may be taken by the seller 550, by a marketing consultant supplied by the service provider, or by some other party. The computing device 510 may run one or more application programs suitable to create marketing materials and/or a web page relating to the property for sale. The computing device 510 may interface with the at least one printer 520, the server 530, and the VRS 540 by means of one or more communication paths 515. The one or more communication paths 515 may include direct connections and connections via one or more networks, which may be the Internet, local area networks, wide area networks, and other networks.

The at least one printer 520 may include a conventional computer page printer for printing marketing materials such as flyers. The at least one printer 520 may include a device for making large format signs, such as a large format printer, a stencil cutter, a vinyl cutter, or other means for creating signs.

The server 530 may be one or more computing devices, as previously defined, capable of receiving inquiries from potential buyers 570 and other interested parties and responding by sending a web page or pages relating to the property for sale. The server 530 may receive inquires from potential buyers 570 using personal computing devices 580 via the Internet 535. The server 515 may receive the Web page relating to the property, or data required to create the Web page, from the computing device 510.

The VRS 540 may receive inquires from potential buyers 570 via telephones 590 and a telephone network 545. In response to inquiries, the VRS may play a prerecorded message relating to the property for sale, which may be recorded using the computing device 510 running an appropriate software application. The VRS may respond by having a human operator or a voice synthesis system read a prepared script relating to the property for sale.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A method for obtaining leads for a service provider, comprising:
the service provider supplying marketing support to a seller having a first real property available for sale, the marketing support including marketing materials containing property contact information to direct inquiries to the service provider
the service provider receiving inquiries from one or more potential buyers in response to the property contact information
the service provider responding to the inquiries from the potential buyers on behalf of the seller, the service provider collecting buyer contact information of the potential buyers for use as leads.

2. The method for obtaining leads of claim 1, wherein responding to the inquires from potential buyers comprises
providing information relating to the first real property
providing additional information related to financing the purchase of the first real property or other real property.

3. The method for obtaining leads of claim 1, wherein the property contact information comprises a phone number.

4. The method of obtaining leads of claim 3, wherein responding to the inquires from potential buyers comprises providing a prepared message to potential buyers who call the phone number.

5. The method for obtaining leads of claim 3, wherein the phone number is unique to the real property.

6. The method for obtaining leads of claim 1, wherein
the property contact information comprises a URL
responding to the inquires from potential buyers comprises providing a Web page to potential buyers who access the URL.

7. The method for obtaining leads of claim 6, wherein the URL and the Web page are unique to the first real property.

8. The method for obtaining leads of claim 6, wherein the property contact information further comprises a unique identifier unique that may be used to access information relating to the first real property through the Web page.

9. The method for obtaining leads of claim 1, wherein
the property contact information is included on at least one of a sign provided to the seller as part of the marketing materials, literature provided to the seller as part of the marketing materials, and advertisements placed by the seller.

10. The method for obtaining leads of claim 1, wherein
the marketing support is supplied without cost to the seller.

11. The method for obtaining leads of claim 1, wherein
the marketing support is supplied to the seller in return for a commitment by the seller to at least one of holding a predetermined number of open house events and placing advertisements at predetermined intervals.

12. The method for obtaining leads of claim 11, further comprising
the seller obtaining buyer contact information for potential buyers attending the open house events
the seller supplying the buyer contact information to the service provider for use as leads.

13. The method for obtaining leads of claim 1, further comprising
the service provider sharing the leads with a second service provider
the second service provider using the buyer contact information to supply service information to the potential buyers, the service information describing a product or service related to purchasing the first real property or a similar property.

14. The method for obtaining leads of claim 13, wherein the product or service is selected from the group consisting of financing, repairs, remodeling, property insurance, title insurance, moving, home warrantee, inspection, pest control, appraisal, escrow services, and other services related to the sale or purchase of real estate.

15. The method for obtaining leads of claim 1, wherein
the marketing support supplied to the seller includes providing access to a consultant to assist the seller in marketing the first property.

16. A method for obtaining leads for a business, comprising:
the business supplying marketing materials to a seller having a first property available for sale, the marketing materials including business contact information to direct inquiries to the business
the business receiving inquiries from one or more potential customers in response to the marketing materials
the business responding to the inquiries from the potential customers on behalf of the seller, the business collecting customer contact information of the potential customers for use as leads.

17. The method for obtaining leads of claim 16, wherein responding to the inquires from potential customers comprises
providing information relating to the first property
providing additional information describing a product or service related to the first property or a similar property.

18. The method for obtaining leads of claim 16, wherein the business contact information comprises at least one of a phone number and a URL.

19. The method for obtaining leads of claim 18, wherein
responding to the inquires from potential customers comprises providing at least one of providing a prepared message to potential customers who call the phone number and providing a Web page to potential customers who access the URL.

20. The method for obtaining leads of claim 18, wherein
the business contact information is included on at least one of a sign provided to the seller as part of the marketing materials, literature provided to the seller as part of the marketing materials, and advertisements placed by the seller.

21. The method for obtaining leads of claim 16, wherein
the marketing materials are supplied without cost to the seller.

22. The method for obtaining leads of claim 16, wherein
the marketing materials are supplied to the seller in return for a commitment by the seller to place at least one advertisement including the business contact information.

23. The method for obtaining leads of claim 16, further comprising
the business using the customer contact information to supply sales information to the potential customers, the sales information describing a product or service related to the first property.
